(19) United States
(12) Patent Application Publication
(10) Pub. No.: US 2009/0150949 A1
(43) Pub. Date: Jun. 11, 2009

(54) METHOD OF PROVIDING CONTINUOUS STREAMING SERVICE USING IPTV AND APPARATUS THEREFOR

(75) Inventors: Chang-sup Keum, Daejeon (KR); Young-il Choi, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics & Telecommunications Research Institute, Daejeon (KR)

(21) Appl. No.: 12/127,555

(22) Filed: May 27, 2008

(30) Foreign Application Priority Data
Dec. 6, 2007 (KR) 10-2007-0126357

(51) Int. Cl. H04N 7/173

(52) U.S. Cl. 725/109

(57) ABSTRACT

Provided are a method and an apparatus for providing a continuous streaming service using an Internet protocol television (IPTV). The method comprises: receiving a request for the streaming service to be provided continuously to a different terminal while the streaming service is being provided to one terminal; converting contents data that is being provided to the terminal into contents data which is to be provided to the different terminal based on subscription information and terminal information of the different terminal in response to the request from the different terminal; and providing the streaming service of the converted contents data continuously to the different terminal. Accordingly, the streaming service which is being provided to the terminal can be continuously provided to the different terminal in real-time.

### CROSS REFERENCE TO RELATED APPLICATIONS

This application claims priority from Korean Patent Application No. 10-2007-0126357, filed on Dec. 6, 2007, the disclosure of which is incorporated herein in its entirety by reference.

### BACKGROUND OF THE INVENTION

1. Field of the Invention

The present invention relates to a communication network service technology, and more particularly, to a communication network service technology using an Internet protocol television (IPTV).

This work was partly supported by the IT R&D program of Ministry of Information and Communication (MIC)/Institute for Information Technology Advancement (IITA) [2005-S-056-03, Development of Open API and Service Platform Technologies].

2. Description of the Related Art

An Internet protocol television (IPTV) service is a two-way television service that is provided through a high-speed Internet network. An IPTV service enables a viewer to watch a desired program at any time the viewer wants, and thereby increasing in the use of the service.

Specifically, an IPTV can provide an information service, moving picture contents, and broadcasting through a high-speed Internet. That is, the IPTV can be regarded as a type of digital convergence in view of combination of the Internet and the television. Thus, users can be provided with various contents and additional services through the IPTV, such as Internet browsing, movie services, home shopping, home banking, online games, and MP3 downloads, which are provided by the Internet.

In particular, the IPTV advantageously provides a streaming service. The streaming service enables a real-time reproduction of multimedia contents data. Hence, a user can use multimedia contents data subsequently through the Internet network without needing to download the contents data.

That is, users can reproduce voice, image, or animation data in real-time. As a result, users does not spend time on downloading and reproducing the multimedia data and can use the multimedia data in real-time.

However, when contents data is being provided to one terminal and a user wants to be provided with the contents data through a different terminal, a streaming service cannot provide the contents data continuously to the different terminal. In other words, when the user wants to change the terminal to which the contents data is provided and keep using the same contents data continuously through the changed terminal, the user only can view the contents data not from the point of time of requesting for the continuous streaming service, but from the beginning of the contents data.

For example, when a user uses a mobile phone for a streaming service on the move and comes back home, the user may want to change the mobile phone to a large IPTV for a high-quality multimedia service.

At this time, the user can be provided with the high-quality multimedia service through the large IPTV, but cannot be provided with a continuous streaming service. Thus, the user needs to keep using the mobile phone of a small screen in order to use the contents data that the user has been watching, or needs to be provided with the same streaming service from the beginning for the high-quality contents data to be reproduced by the IPTV.

As described above, if the continuous streaming service is not provided, a user may waste time on procedures for re-performing the same streaming service.

### SUMMARY OF THE INVENTION

The present invention provides a method and an apparatus for providing a continuous streaming service, whereby a user can be provided with the seamless and continuous streaming service through a terminal different from a terminal to which the continuous streaming service is provided.

Additional aspects of the invention will be set forth in the description which follows, and in part will be apparent from the description, or may be learned by practice of the invention.

The present invention discloses a method of providing a streaming service using an Internet protocol television (IPTV), the method comprising: receiving a request for the streaming service to be provided continuously to a different terminal while the streaming service is being provided to one terminal; converting contents data that is being provided to the terminal into contents data which is to be provided to the different terminal based on subscription information and terminal information of the different terminal in response to the request from the different terminal; and providing the streaming service of the converted contents data continuously to the different terminal.

The present invention also discloses an apparatus for providing a continuous streaming service using an Internet protocol television (IPTV), the apparatus comprising: a request receiving unit which receives a request for the streaming service to be provided continuously to a different terminal while the streaming service is being provided to one terminal; and a contents data converting unit which converts contents data being provided to the terminal into contents data to be provided to the different terminal based on subscription information and terminal information of the different terminal in response to the received request.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 is a view for explaining an operation of an apparatus for providing a continuous streaming service according to an embodiment of the present invention.

FIG. 2 is a block diagram of an apparatus for providing a continuous streaming service according to an embodiment of the present invention.

FIG. 3 is a flowchart illustrating a method of providing a continuous streaming service according to an embodiment of the present invention.

FIG. 4 is a flowchart illustrating streaming service procedures between a continuous streaming service providing apparatus and terminals according to an embodiment of the present invention.

### DETAILED DESCRIPTION OF EXEMPLARY EMBODIMENTS

A preferred embodiment of the present invention will be described herein below with reference to the accompanying drawings. In the following description, well-known functions or constructions are not described in detail since they would obscure the invention in unnecessary detail. The terms used herein are defined in consideration of the functions of elements in the present invention. The terms can be changed according to the intentions or the customs of a user and an operator.

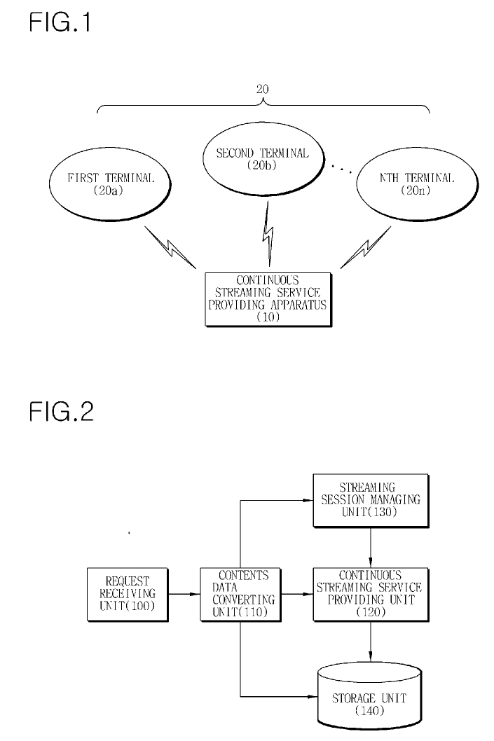

FIG. 1 is a view for explaining an operation of an apparatus 10 for providing a continuous streaming service according to an embodiment of the present invention.

The apparatus 10 provides a streaming service using an Internet protocol television (IPTV). A streaming continuous service using an IPTV uses a standardized web protocol such as hypertext transfer protocol (HTTP) and data format such as an extensible mark-up language (XML). Hence, regardless of a particular platform of an operating system (OS), smooth flow of data between all terminals can be assured.

When a streaming service provided to one terminal is shifted to a different terminal, the continuous streaming service according to the current embodiment of the present invention enables the streaming service to be provided continuously to the different terminal without the terminal's needing to reproduce the streaming service from the beginning. In this case, the streaming service provided to the different terminal continues from the point of stopping.

A first, a second, and a third terminal 20A, 20B, and 20C can be any apparatuses that can use the IPTV service. The first, second, and third terminals 20A, 20B, and 20C may be Internet-based televisions, or mobile devices. For example, the terminals 20A, 20B, and 20C may be mobile phones, laptop computers, or portable multimedia players (PMPs).

The apparatus 10 for providing the continuous streaming service can stop providing a streaming service to a terminal and then provide the same streaming service continuously to a different terminal from the point of stopping. For example, as shown in FIG. 1, when the apparatus 10 provides a streaming service to the first terminal 20A, the apparatus 10 can provide the service to the second terminal 20B in response to a request of a user. At this time, the streaming service may be preferably stopped being provided to the first terminal 20A.

The apparatus 10 may be integrated with a server which controls IPTV broadcasting, or may be an application server which is implemented separately from a server that provides the IPTV broadcasting. Additionally, the apparatus 10 can provide the streaming service which is being provided to a single terminal to a plurality of different terminals. Accordingly, a user or a plurality of users can be simultaneously provided with the continuous streaming service using various terminals 20A, 20B, and 20C.

FIG. 2 is a block diagram of an apparatus 10 for providing a continuous streaming service according to an embodiment of the present invention. Referring to FIG. 2, the apparatus includes a request receiving unit 100 and a contents data converting unit 110. Also, the apparatus 10 may further include a continuous streaming service providing unit 120, a streaming session managing unit 130, and a storage unit 140. Each of elements may be implemented as a respective server, or the elements may be implemented as an integrated server.

While being providing a streaming service to a terminal, the request receiving unit 100 receives messages from other terminals that request the apparatus 10 to provide the streaming service continuously to the terminals. For example, when a user views an IPTV streaming service using a mobile phone on the subway, comes back home and wants to keep watching the same IPTV streaming service through an IPTV with a large screen, the request receiving unit 100 may receive request message for a continuous streaming service from the IPTV terminal with the large screen.

The contents data converting unit 110 converts contents data that is being provided to a terminal into contents data that is to be transmitted to other terminals based on the subscription information and terminal information of the other terminals in response to the request message for a continuous streaming service received by the request receiving unit 100.

The subscription information is for verifying if the other terminals are subscribed to the continuous streaming service. For more information, the subscription information may include a service subscriber identifier, whether the terminals have subscribed to additional services, and subscriber bill information.

When the user is verified to subscribe to the continuous streaming service based on the subscription information of the other terminals described above, the contents data converting unit 110 may convert the contents data that is being provided to one terminal into data contents that can be transmitted to the other terminals based on the terminal information of the other terminals.

The terminal information may include accessibility to the continuous streaming service or terminal's features for contents data quality. The accessibility to the continuous streaming service may be information about whether the terminal is using the continuous streaming service, which is based on the terminal identifier, and the accessibility to the continuous streaming service providing unit 120 that continuously provides the streaming service.

The features of the terminal for the contents data quality may include a size, the resolution, and codec information of the terminal. For instance, a large IPTV has a screen greater than a screen of a mobile phone, and a higher resolution, and uses a high-quality codec. Consequently, when the streaming service is being provided to the mobile phone and the user wants to continuously use the streaming service using the large IPTV, the contents data converting unit 110 converts the contents data according to the size, the resolution, and the codec of the IPTV.

The continuous streaming service providing unit 120 continuously provides the streaming service to another terminal. The continuous streaming service providing unit 120 may be a contents server that provides the contents.

In this case, the apparatus 10 may search a contents server which corresponds to the subscription information and the terminal information of the different terminal in order to provide the streaming service to the different terminal. When a server is found which has a high accessibility or is available to provide the contents smoothly, the streaming service can be continuously provided to the different terminal.

Accordingly, the apparatus 10 can provide the streaming service, which has been provided to one terminal, continuously to a different terminal. Thus, it does not need to provide the streaming service from the beginning when the user wants to use the streaming service through another terminal.

The streaming session managing unit 130 manages streaming session of the terminal, to which the streaming service is being provided, or another terminal, to which the streaming service is to be provided, based on the subscription information of the terminals. The streaming session managing unit 130 can control the start or end of the streaming session of the terminals.

For more information, when the streaming service is continuously provided to the different terminal, the streaming session managing unit 130 can end the streaming session with the previous terminal. Then, the streaming session with the different terminal may be preferably set up to provide the stopped streaming service.

The storage unit 140 stores a usage history of the terminal for the continuous streaming service. The contents data converting unit 140 can convert the contents data that is being provided to the terminal into the data contents to be transmitted to a different terminal by using the usage history stored in the storage unit 140. The subscription information and the terminal information of the user may be preferably stored together with the usage history.

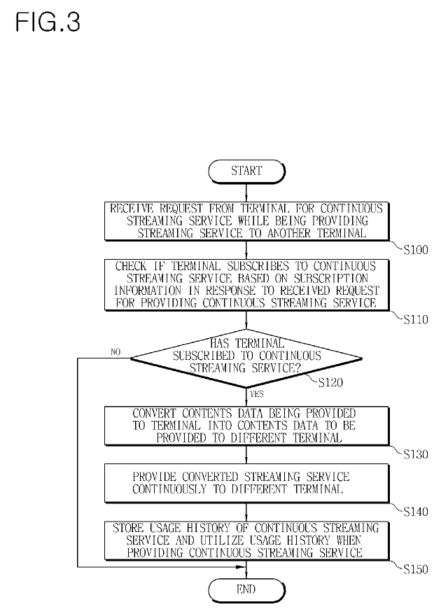

FIG. 3 is a flowchart illustrating a method of providing a continuous streaming service according to an embodiment of the present invention. Referring to FIG. 3, when an IPTV streaming service is being provided to one terminal and a user wants to be provided with the IPTV streaming service to a different terminal, a request message for the continuous streaming service is received from the different terminal (operation S100). It is checked if the different terminal has subscribed to the continuous streaming service based on the subscription information of the terminal (operation S110). The subscription information is for verifying if the terminal has subscribed to the continuous streaming service, and may include a service subscriber identifier, whether the terminal has subscribed to an additional service, and subscriber bill information.

When it is determined that the terminal that requests the continuous streaming service has not subscribed to the continuous streaming service (operation S120), the apparatus 10 for providing the continuous streaming service does not provide the contents data to the terminal. Alternatively, when it is determined that the terminal which requests the continuous streaming service has subscribed to the continuous streaming service, the apparatus 10 converts the contents data, which is provided to the previous terminal, into contents data to be provided to the terminal, which requests the continuous streaming service, based on the terminal information (operation S130).

Here, the terminal information may include accessibility of the terminal to the continuous streaming service and the terminal's features for the contents data quality. Specifically, the accessibility may be information about if the terminal is using the continuous streaming service and if the terminal can access the continuous streaming service providing unit 120. Moreover, the terminal's features for the contents data quality may be information including the size, the resolution, and codec information of the terminal.

The apparatus 10 for providing the continuous streaming service provides the converted contents data to the different terminal continuously (operation S140). At this time, the contents data which has been provided to a previous terminal is preferably stopped from being provided to the previous terminal.

Furthermore, the apparatus 10 stores a usage history of the continuous streaming service to be used when the continuous streaming service is provided (operation S150).

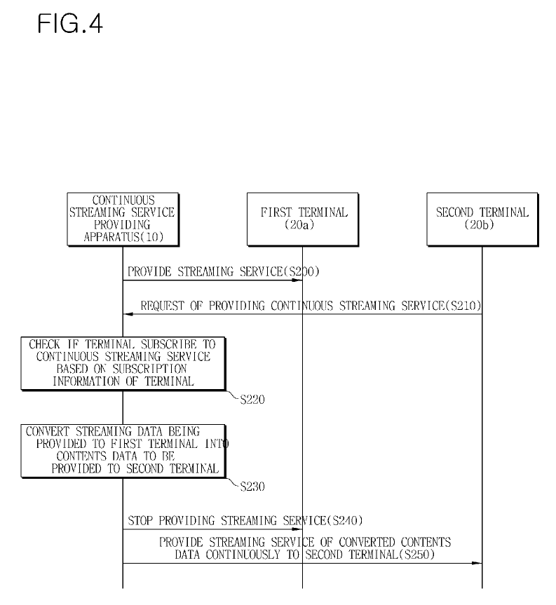

FIG. 4 is a flowchart illustrating streaming service procedures between a continuous streaming service providing apparatus 10 and terminals 20A and 20B according to an embodiment of the present invention. Referring to FIG. 4, the continuous streaming service providing apparatus 10 provides a streaming service to one terminal, for example, a first terminal 20A (operation S200). In this case, the apparatus 10 may receive a request from another terminal, for example, a second terminal 20B that wants to be provided with the same streaming service continuously (operation S210).

The continuous streaming service providing service 10 checks if the second terminal 20B has subscribed to the continuous streaming service based on subscription information of the terminal 20B (operation S220). When the second terminal 20B is verified to subscribe to the continuous streaming service, contents data which is being provided to the first terminal 20A is converted into contents data to be provided to the second terminal 20B based on terminal information of the second terminal 20B.

The continuous streaming service providing apparatus 10 stops providing the streaming service to the first terminal 20A (operation S240), and provides the converted contents data, starting from the point of stopping, to the second terminal 20B (operation S250).

In short, the continuous streaming service providing apparatus 10 can provide a continuous streaming service to all terminals that have subscribed to the continuous streaming service. This is because the contents data can be converted based on subscription information and terminal information of the terminals to be provided with the continuous streaming service.

Accordingly, when a streaming service is provided to one terminal, the continuous streaming service providing apparatus 10 can provide the streaming service continuously to a different terminal in real-time. Also, since the terminal does not need to stand by to be provided with the contents data, a user can use the streaming service in real-time even when changing the terminals.

As described above, according to the present invention, a streaming service which is being provided to a terminal can be continuously provided to a different terminal in real-time. Hence, when a user wants to use contents data continuously through a different terminal, the user does not need to be inconvenienced by the process of having the contents data provided from the beginning of the data.

Furthermore, since a stand-by time to download contents data is not required, the user can use the continuous streaming service in real-time regardless of the change in terminals.

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of providing a streaming service using an Internet protocol television (IPTV), the method comprising:
receiving a request for the streaming service to be provided continuously to a different terminal while the streaming service is being provided to one terminal;
converting contents data that is being provided to the terminal into contents data which is to be provided to the different terminal based on subscription information and terminal information of the different terminal in response to the request from the different terminal; and
providing the streaming service of the converted contents data continuously to the different terminal.

2. The method of claim 1, wherein the converting of the contents data includes checking if the different terminal has subscribed to the continuous streaming service based on the subscription information of the different terminal in response to the request, and converting the contents data that is being provided to the terminal into contents data which is to be provided to the different terminal based on the terminal information of the different terminal when the different terminal is verified to subscribe to the continuous streaming service.

3. The method of claim 2, wherein in the converting of the contents data, the contents data being provided to the terminal is converted into contents data to be provided to the different terminal based on the different terminal's information regarding service accessibility and terminal features for contents data quality.

4. The method of claim 1, wherein in the providing of the streaming service of converted contents data, the streaming service is stopped from being provided to the terminal and the streaming service of the converted contents data is provided continuously to the different terminal.

5. The method of claim 1, further comprising:
storing a usage history of the continuous streaming service that is provided to the different terminal so that the usage history is used when the streaming service is continuously provided.

6. An apparatus for providing a continuous streaming service using an Internet protocol television (IPTV), the apparatus comprising:
a request receiving unit which receives a request for the streaming service to be provided continuously to a different terminal while the streaming service is being provided to one terminal; and
a contents data converting unit which converts contents data being provided to the terminal into contents data to be provided to the different terminal based on subscription information and terminal information of the different terminal in response to the received request.

7. The apparatus of claim 6, further comprising:
a continuous streaming service providing unit which provides the streaming service of the converted contents data continuously to the different terminal.

8. The apparatus of claim 6, further comprising:
a session managing unit which manages streaming session of both terminals based on the subscription information of the terminals.

9. The apparatus of claim 8, wherein the session managing unit stops providing the streaming service to the terminal and provides the streaming service of the converted contents data continuously to the different terminal.

10. The apparatus of claim 6, wherein the terminal information of the different terminal includes service accessibility and terminal features for contents data quality.

11. The apparatus of claim 6, further comprising:
a storage unit which stores a usage history of the continuous streaming service that is provided to the different terminal,
wherein the contents data converting unit converts the contents data being provided to the terminal into the contents data to be provided to the different terminal by using the usage history.
